(19) United States
(12) Patent Application Publication
(10) Pub. No.: US 2006/0216471 A1
(43) Pub. Date: Sep. 28, 2006

(54) Pitch modulating laminate with an apertured acoustic layer

(75) Inventors: Michael D. Grah, Simpsonville, SC (US); Janet W. Rivett, Simpsonville, SC (US)

Correspondence Address: Sealed Air Corporation, P.O. Box 464, Duncan, SC, 29334, US

(73) Assignee: Cyovac, Inc.

(21) Appl. No.: 11/091,161

(22) Filed: Mar. 28, 2005

(51) Int. Cl. B32B 3/10

(52) U.S. Cl. 428/137

(57) ABSTRACT

A laminate comprises a core layer and one or more acoustic layers adhered to the core layer. The core layer is at least about 30 mils thick and comprises one or more materials selected from wood and wood composite. The total thickness of the one or more acoustic layers is greater than about 5 mils. The one or more acoustic layers define a plurality of apertures, and either have a glass transition temperature of at most about 0° C. along with a crystallinity of at most about 39 weight %, or comprise at least about 40 weight % elastic polymer, or both. The laminate may be useful in flooring systems.

### BACKGROUND OF THE INVENTION

The present invention relates to laminates, for example, laminates useful in flooring systems.

Laminate flooring products are manufactured to present an appearance similar to solid hardwood flooring. However, an installed laminate floor may not sound the same as a solid hardwood floor. For example, the sound of hard-soled shoes walking on a laminate floor may sound noticeably louder or higher pitched than the sound of hard-soled shoes walking on a solid hardwood floor. A consumer may perceive this sound difference as indicating a floor of lesser quality.

### SUMMARY OF THE INVENTION

The present invention addresses one or more of the aforementioned problems. A laminate comprises a core layer and one or more acoustic layers. The core layer comprises one or more materials selected from wood and wood composite. The core layer has a thickness of at least about 30 mils. The one or more acoustic layers are adhered to the core layer. The one or more acoustic layers define a plurality of apertures. The total thickness of the one or more acoustic layers is greater than about 5 mils. The one or more acoustic layers comprise one or more polymers, and either have a glass transition temperature of at most about 0° C. along with a crystallinity of at most about 39 weight %, or comprise at least about 40 weight % elastic polymer, or both.

The laminate may have a lower intensity of reflected impact sound at higher frequency ranges. The laminate may sound more similar to solid hardwood than some conventional floor laminates. The apertured acoustic layer may enhance the transmission of water vapor through the laminate.

These and other advantages and features of the invention will be more readily understood and appreciated by reference to the detailed description of the invention and the drawings.

### BRIEF DESCRIPTION OF THE DRAWINGS

FIG. 1 is a representational side elevation cross section view of a laminate 10 according to the present invention; and

FIG. 2 is a representational side elevation cross section view of a floor system 40 according to the present invention comprising laminate 30.

FIG. 3 is a representational side elevation cross section view of a laminate 10 according to the present invention, which comprises an apertured acoustic layer 14; and

FIG. 4 is a representational side elevation cross section view of a floor system 40 according to the present invention comprising laminate 30, which comprises apertured acoustic layer 14.

Similar elements in different drawings may use the same reference number.

### DETAILED DESCRIPTION OF THE INVENTION

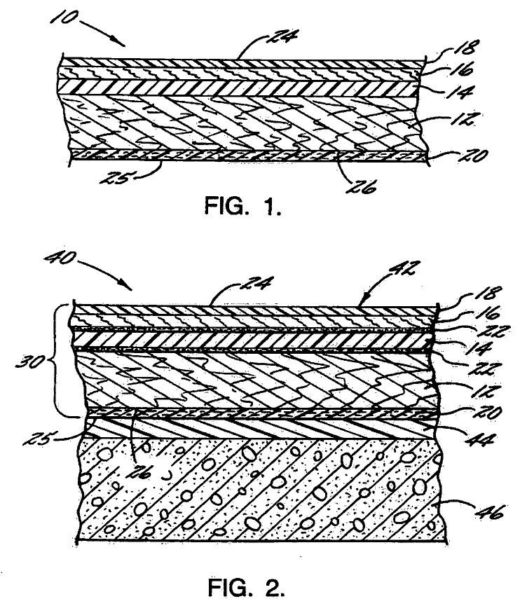

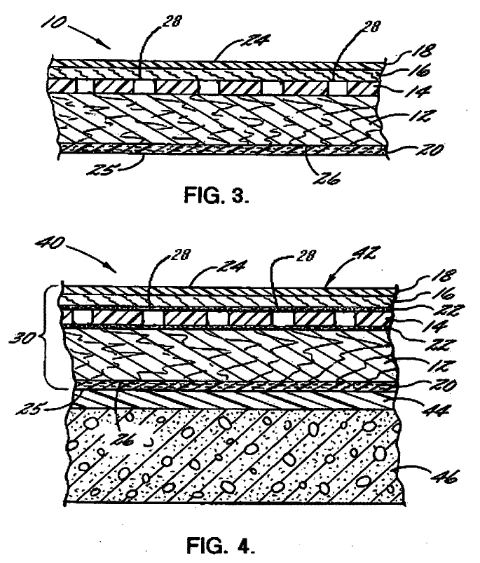

Laminates 10, 30 of the present invention may comprise a core layer 12 and one or more acoustic layers 14 adhered to the core layer. (FIGS. 1 and 2.) Additional layers may include a decorative layer 16, a wear layer 18, a backing layer 20, and an adhesive layer 22. The one or more acoustic layers 14 may define a plurality of apertures 28. (FIGS. 3 and 4.)

The laminate may have thickness of at least about any of the following: 35, 50, 80, 100, 150, 200, 300, 500, and 800 mils; and/or at most about any of the following: 3, 2, 1.5, 1, 0.8, 0.5, 0.3, 0.2, 0.15, 0.1, and 0.05 inches. The laminate may be configured as planks, for example, from about 3 to about 6 inches wide and from about 6 to about 8 feet long; as squares, for example, from about 10 to about 18 inches in length; or as sheets, for example, from about 2 to about 6 feet wide and from about 5 to about 10 feet long (e.g., 4 feet by 8 feet).

The laminate defines a top surface 24 on one side of the laminate and a bottom surface 25 on the opposite side of the laminate. The top surface of the laminate is the face of the laminate intended to be visually displayed upon installation in a desired end use; whereas, the bottom surface 25 is generally intended not to be the featured side of visual display upon installation in the desired end use.

### Core Layer

The core layer 12 of the laminate functions primarily to provide strength, adequate rigidity, and structural integrity to the laminate. The core layer may comprise one or more materials selected from wood (e.g., lumber board) and wood composites. Exemplary wood composites include plywood, fiberboard, particle board, and oriented strand board (OSB). Exemplary fiberboard includes medium density fiberboard (MDF) and high density fiberboard (HDF). The core layer may have a thickness of at least about any of the following: 30, 50, 80, 100, 120, 150, 180, 200, 220, 250, 280, 300, 350, and 400 mils; and/or at most about any of the following: 5, 4, 3, 2, 1, 0.8, 0.5, 0.25, 0.2, 0.15, 0.1, 0.08, 0.05, 0.03, and 0.01 inches.

### Acoustic Layer

The laminate may comprise one or more acoustic layers 14. (Although FIGS. 1-4 illustrate item 14 as one acoustic layer, item 14 may also represent one or more acoustic layers in these Figures.) An acoustic layer, or one or more acoustic layers, may have a thickness and composition effective to reduce the intensity of the reflective impact sound preferentially in the 1,000Hz to 12,500 Hz range, and/or in the 4,000 Hz to 12,500 Hz range, in comparison to the impact sound pitch of a similar laminate lacking the acoustic layer or layers. The laminate comprising the one or more acoustic layers may better mimic the reflective impact sound of a solid oak hardwood floor compared to a similar laminate lacking the acoustic layer or layers.

An acoustic layer comprises one or more polymers, for example, one or more of any of the polymers set forth in this application, such as one or more elastic polymers discussed below. An acoustic layer may comprise the one or more polymers in any of the amounts set forth in this application with respect to elastic polymers.

An acoustic layer may have a glass transition temperature (“Tg”) of at most about any of the following: 0, −2, −3, −5, −10, −15, −20, −25, −30, −35, −40, −45, −50, −60, −70, −80, −90, and −120° C.; and/or at least about any of the following: −200, −180, −150, −120, −100, −80, and −60° C. Unless specified otherwise, the Tg is measured at a relative humidity of 0%. All references to the glass transition temperature of a polymer, a polymer mixture, a resin, a film, or a layer in this Application refer to the characteristic temperature at which amorphous polymers, or the amorphous part of semi-crystalline polymers, of the sample changes from a hard, glassy, or brittle state to a soft, flexible, rubbery state, as measured by dynamic mechanical analysis (“DMA”) according to ASTM D4065 and ASTM D5026, using a dynamic displacement frequency of 22 radians/second, an amplitude of displacement of 0.1% strain, a thermal gradient of 3° C./minute, and a nitrogen atmosphere, where the temperature is ramped from −150° C. up to the point of loss of transducer sensitivity (i.e., when the film falls apart). The Tg is the tan delta beta transition peak temperature averaged for two samples.

An acoustic layer may be substantially amorphous. An amorphous polymer, resin, or layer is one that does not clearly display a melting point. All references to the melting point of a polymer, a resin, or a layer in this Application refer to the melting peak temperature of the dominant melting phase of the polymer, resin, or layer as determined by differential scanning calorimetry according to ASTM D-3418.

An acoustic layer may be non-crystalline or partially crystalline (i.e., semi-crystalline). For example, an acoustic layer may have a crystallinity of at most about any of the following weight percentages: 0, 5, 10, 15, 20, 25, 30, 33, 35, 38, and 39%, based on the weight of the acoustic layer. An acoustic layer may also have a crystallinity of at least about any of the following weight percentages, 2, 5, 8, 10, 15, 20, 25, 30, and 35%, based on the weight of the acoustic layer. One or more acoustic layers may have any of the aforementioned crystallinities, and in that sense “based on the weight of the acoustic layer” means that each of the one or more acoustic layers has the recited crystallinity weight percentage based on the individual weight of the respective acoustic layers. Unless specified otherwise, the crystallinity of the one or more acoustic layers is “based on the weight of the acoustic layer” in the sense explained above.

The crystallinity may be determined indirectly by the thermal analysis method, which uses heat-of-fusion measurements made by differential scanning calorimetry (“DSC”). All references to crystallinity percentages of a polymer, a polymer mixture, a resin, a film, or a layer (e.g., an acoustic layer) in this Application are by the DSC thermal analysis method, unless otherwise noted. The DSC thermal analysis method is believed to be the most widely used method for estimating polymer crystallinity, and thus appropriate procedures are known to those of skill in the art. See, for example, “Crystallinity Determination,” Encyclopedia of Polymer Science and Engineering, Volume 4, pages 482-520 (John Wiley & Sons, 1986), of which pages 482-520 are incorporated herein by reference.

Under the DSC thermal analsysis method, the weight fraction degree of crystallinity (i.e., the “crystallinity” or “Wc”) is defined as ΔHf/ΔH°f,c, where “ΔHf” is the measured heat of fusion for the sample (i.e., the area under the heat-flow versus temperature curve for the sample) and “ΔH°f,c” is the theorectical heat of fusion of a 100% crystalline sample. The ΔH°f,c values for numerous polymers have been obtained by extrapolation methods; see for example, Table 1, page 487 of the “Crystallinity Determination” reference cited above. The ΔH°f,c for polymers are known to, or obtainable by, those of skill in the art. The ΔH°f,c for a sample polymer material may be based on a known ΔH°f,c for the same or similar class of polymer material, as is known to those of skill in the art. For example, the ΔH°f,c for polyethylene may be used in calculating the crystallinity of an EVA material, since it is believed that it is the polyethylene backbone of EVA rather than the vinyl acetate pendant portions of EVA, that forms crystals. Also by way of example, for a sample containing a blend of polymer materials, the ΔH°f,c for the blend may be estimated using a weighted average of the appropriate ΔH°f,c for each of the polymer materials of separate classes in the blend.

The DSC measurements may be made using a thermal gradient for the DSC of 10° C./minute. The sample size for the DSC may be from 5 to 20 mg.

A laminate comprising one or more acoustic layers having a higher amount of elasticity may improve the preferential impact sound reduction at higher frequencies for the laminate. An acoustic layer may have elasticity characterized by a combination of crystallinity (if any) and Tg. For example, an acoustic layer may exhibit a combination of any of the crystallinity and Tg values recited above.

Also by way of example, the Tg (° C.) of an acoustic layer may be at most about the value given by the expression:
5−(Y*Wc)
where “Wc” is the weight percent crystallinity of the acoustic layer and “Y” may be a number selected from 1, 2, 3, 4, and 5. For example, if the “Wc” of the acoustic layer is 30 wt % and “Y” is specified as 3, then the Tg of the acoustic layer may be at most about −85° C.

An acoustic layer or the one or more acoustic layers may be essentially non-cellular. An acoustic layer or the one or more acoustic layers may comprise a cellular structure, that is, may comprise a foam. An acoustic layer may comprise a closed cell configuration or an open cell configuration. The term “closed cell” configuration as used herein means that the layer comprises an open cell content of 30 volume % or less, measured according to ASTM D2856-94 (Procedure A). (For a layer having a thickness of less than 0.984 inches, then the sample size shall be 0.984 inches by 0.984 inches by the actual average thickness of the sample.) The term “open cell” refers to an open cell content of greater than 30 volume %, measured according to the same standards.

An acoustic layer may have an average cell size of at least about any of the following values: 0.01, 0.05, 0.1, 0.5, and 1 mm. An acoustic layer may have an average cell size of at most about any of the following values: 10, 5, 3, 1, and 0.5 mm. The average cell size may be measured according to ASTM D3576-98 (Procedure A).

The density of a cellular acoustic layer may be at least about any of the following: 0.5, 1, 3, 5, 8, 10, 12, 15, 20, 25, 30, and 35 pounds per cubic foot (lb/ft3). The density of the cellular acoustic layer may be at most about any of the following values: 40, 35, 30, 25, 20, and 15 lb/ft3. The density may be measured according to ASTM D3575-00, Suffix W, Test Method A, which is incorporated herein in its entirety by reference.

The one or more acoustic layers 14 may be adhered to the core layer 12. A first layer may be considered as adhered to a second layer even where intervening layers exist between the first and second layers, for example intervening layers such as adhesive layers, decorative layers, strength layers, wear layers, core layers, acoustic layers, or layers of other functionality.

An acoustic layer may be directly adhered to the core layer. A first layer is “directly adhered” to a second layer if the first and second layers are bonded to each other without any intervening layer, such as an adhesive layer.

The thickness of an acoustic layer, or the total thickness of the one or more acoustic layers, may be greater than about 5 mils. The thickness of an acoustic layer, or the total thickness of the one or more acoustic layers, may be at least about and/or at most about any of the following thicknesses: 8, 10, 13, 15, 20, 25, 30, 35, 40, 50, 55, and 60 mils. The ratio of the total thickness of the one or more acoustic layers to the thickness of the core layer may be at least about, and/or at most about, any of the following: 0.02, 0.05, 0.1, 0.2, 0.3, 0.4, 0.5, 0.7, 0.9, 1, 1.2, and 1.5.

The one or more acoustic layers may be at least about, and/or at most about, any of the following distances from the top surface of the laminate: 1, 4, 5, 8, 10, 13, 15, 20, 25, 30, 35, 40, 50, 55, 60, 80, 100, and 200 mils. As used in this sense, the distance is the length from the top surface to the first encounter with an acoustic layer of the one or more acoustic layers.

The one or more acoustic layers may be at least about, and/or at most about, any of the following distances from the core layer of the laminate: 1, 4, 5, 8, 10, 13, 15, 20, 25, 30, 35, 40, 50, 55, 60, 80, 100, and 200 mils. As used in this sense, the distance is the length from the core layer to the first encounter with an acoustic layer of the one or more acoustic layers. cl Apertured Acoustic Layer

An acoustic layer (and/or the one or more acoustic layers) 14 may define a plurality of apertures 28 extending through the one or more acoustic layers. (FIGS. 3-4.) The number and configuration of the apertures 28 may be effective to facilitate the transmission of water vapor through the apertured acoustic layer 14, so that water vapor may transmit through the laminate 10, 30 comprising the acoustic layer rather than accumulate or condense within the laminate and possibly deteriorate the performance and integrity of the laminate.

The water vapor transmission rate through the apertured acoustic layer may be, for example, at least about, and/or at most about, any of the following values: 1, 2, 5, 10, 15, 20, 40, 50, 60, 80, 100, 150, 200, 250, 300, 400, 500, and 1,000 grams/100 in².24 hours (100% humidity, 23° C.), measured according to ASTM F 1249-01 (for values at 20 grams or lower) and ASTM E 96 (for values above 20 grams). All references to water vapor transmission rate in this application are measured at these conditions. Also, the water vapor transmission rate through the laminate that comprises one or more apertured acoustic layers may have any of the water vapor transmission rates set forth above with respect to the apertured acoustic layer.

The plurality of apertures (e.g., holes, perforations) 28 may have a configuration of, or be essentially shaped as, one or more of slits, chevrons, squares, triangles, and circles. The plurality of apertures may be essentially evenly distributed across the acoustic layer, for example, as a regular array of apertures. The average open aperture area per area of acoustic layer of the laminate may be at least about, and/or at most about, any of the following: 0.1, 0.5, 1, 1.5, 2, 2.5, 3, 3.5, 4, 4.5, 5, 5.5, 6, 7, 8, 10, 12, 15, 18, 20, 22, 25, 28, 30, 35, 40, 45, 50, 55, 60, 65, 70, 75, 80, 85, 90, 95, 99%. The average size of the apertures of the acoustic layer of the laminate, expressed as an average cross-section area per aperture, may be at least about, and/or at most about, any of the following values: 1 μm², 5 μm², 10 μm², 50 μm², 100 μm², 500 μm², 0.001 mm², 0.005 mm², 0.01 mm², 0.05 mm², 0.1 mm², 0.5 mm², 1 mm², 1.5 mm², 2 mm², 3 mm², 4 mm², 5 mm², 6 mm², 8 mm², 10 mm², 12 mm², 15 mm², 18 mm², 20 mm², 22 mm², 25 mm², 28 mm², 30 mm², 32 mm², 35 mm², 38 mm², 40 mm², 50 mm², 80 mm², 100 mm², 130 mm², 150 mm², 180 mm², 200 mm², and 300 mm². The average area density of the plurality of apertures for the apertured acoustic layer of the laminate may be at least about, and/or at most about, any of the following values: 2; 5; 10; 15; 20; 25; 30; 35; 40; 45; 50; 55; 60; 70; 80; 90; 100; 150; 200; 300; 500; 1,000; 5,000; 10,000; 50,000; 100,000; 500,000; 1,000,000; 2,000,000; 5,000,000; 10,000,000; and 50,000,000 number of apertures per 100 cm² of apertured acoustic layer.

### Composition of Acoustic Layer

An acoustic layer 14 may comprise one or more elastic polymers in at least about, and/or at most about, any of the following amounts: 40, 50, 60, 70, 80, 90, 95, 98, and 100 weight % (based on the weight of the acoustic layer). An acoustic layer may consist essentially of one or more elastic polymers. An acoustic layer may consist of one or more elastic polymers.

An acoustic layer may comprise a first elastic polymer in at least about and/or at most about any of the following amounts: 40, 50, 60, 70, 80, 90, 95, 98, and 100 weight % (based on the weight of the acoustic layer). An acoustic layer may consist essentially of the first elastic polymer. The acoustic layer may consist of the first elastic polymer.

An acoustic layer may comprise a second elastic polymer in at least about and/or at most about any of the following amounts: 5, 10, 20, 30, 40, and 50 weight % (based on the weight of the acoustic layer).

One or more acoustic layers may have any of the aforementioned weight percentages of elastic polymers, and in that sense “based on the weight of the acoustic layer” means that each of the one or more acoustic layers has the recited weight percentage of elastic polymers based on the individual weight of the respective acoustic layers. Unless specified otherwise, the weight percentages of the one or more acoustic layers is “based on the weight of the acoustic layer” in the sense explained above.

As used herein, an “elastic polymer” is a polymer selected from the following list:
acrylonitrile/chloroprene copolymer,
acrylonitrile/isoprene copolymer,
butadiene/acrylonitrile copolymer,
chlorinated polyethylene,
chlorosulfonated polyethylene,
ethylene ether polysulfide,
ethylene polysulfide,
ethylene/propylene copolymer,
ethylene/propylene/diene terpolymer (e.g., EPDM),
fluoroelastomer,
fluorosilicone,
hexafluoropropylene/vinylidene fluoride copolymer,
isobutene/isoprene copolymer,
organopolysiloxane,
acrylic ester/butadiene copolymer,
polybutadiene,
polychloroprene,
polyepichlorohydrin,
polyisobutene,
polyisoprene (natural or synthetic),
polyurethane (polyester),
polyurethane (polyether),
polyurethane (polyether and polyester),
polyethylene-butyl graft copolymer,
styrenic copolymers (such as styrene/butadiene copolymer, stryene/chloroprene copolymer, and also styrenic block copolymers, such as SBS, SIS, and SEBS),
ethylene/unsaturated ester copolymer (e.g., ethylene/ethyl acrylate copolymer and ethylene/vinyl acetate copolymer, such as ethylene/vinyl acetate copolymer having a vinyl acetate content of at least about 9 weight %),
ethylene/(meth)acrylic acid copolymer (i.e., the copolymer of ethylene and acrylic acid, methacrylic acid, or both), and
ethylene/alpha-olefin copolymer having an average density of at most about 0.912 g/cc.

“Copolymer” as used in this application means a polymer derived from two or more types of monomers, and includes terpolymers, etc. The monomer listed first in the name of the polymer does not necessarily mean that that monomer is present in a majority amount (e.g., “ethylene/propylene copolymer” includes copolymer having 85 weight percent propylene monomer.)

### Styrenic Copolymers

Useful elastic polymers include styrenic copolymers. Styrenic copolymers include styrenic block copolymers such as styrene/butadiene/styrene copolymer (“SBS”), styrene/isoprene/styrene copolymer (“SIS”), styrene/ethylene-butylene/styrene copolymer (“SEBS”), styrene/ethylene-propylene/styrene (“SEPS”), and styrene/ethylene-propylene copolymer (“SEP”). Exemplary SIS and SBS having an unsaturated elastomeric midblock are available from Shell Corporation under the Kraton D trademark. For example, a linear SBS is available under the Kraton D2104 trademark (32% styrene content). Exemplary SEBS and SEPS having a saturated elastomeric midblock are available from Shell Corporation under the Kraton G trademark. Also, for example, an SIS is available from Kuraray Company under the Hybrar trademark (e.g., Hybrar 7125F). Exemplary SEP, SEPS, and SEBS are available from Kuraray Corporation under the Septon trademark. The styrenic block copolymer may be in a hydrogenated or non-hydrogenated form.

### Ethylene/Unsaturated Ester Copolymer

Useful elastic polymers include ethylene/unsaturated ester copolymers. Ethylene/unsaturated ester copolymer is a copolymer of ethylene and one or more unsaturated ester monomers. Useful unsaturated esters include: 1) vinyl esters of aliphatic carboxylic acids, where the esters have from 4 to 12 carbon atoms, and 2) alkyl esters of acrylic or methacrylic acid (collectively, “alkyl (meth)acrylate”), where the esters have from 4 to 12 carbon atoms.

Representative examples of the first (“vinyl ester”) group of monomers include vinyl acetate, vinyl propionate, vinyl hexanoate, and vinyl 2-ethylhexanoate. The vinyl ester monomer may have from 4 to 8 carbon atoms, from 4 to 6 carbon atoms, from 4 to 5 carbon atoms, and preferably 4 carbon atoms.

Representative examples of the second (“alkyl(meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have from 4 to 8 carbon atoms, from 4 to 6 carbon atoms, and preferably from 4 to 5 carbon atoms.

The unsaturated ester (i.e., vinyl ester or alkyl(meth)acrylate) comonomer content of the ethylene/unsaturated ester copolymer may be at least about, and/or at most about, any of the following values: 5, 9, 10, 15, 20, 25, 30, 35, 40, 45, 50, 55, 60, 65, 70, 75, 76, 77, 78, 791, 80, 82, and 85 weight percent comonomer based on the weight of the copolymer. For example, where the ethylene/unsaturated ester copolymer is EVA, the vinyl acetate content may be at most about 75 weight percent.

Representative examples of ethylene/unsaturated ester copolymers include ethylene/methyl acrylate copolymer, ethylene/methyl methacrylate copolymer, ethylene/ethyl acrylate copolymer, ethylene/ethyl methacrylate copolymer, ethylene/butyl acrylate copolymer, ethylene/2-ethylhexyl methacrylate copolymer, and ethylene/vinyl acetate copolymer (“EVA”). Exemplary EVAs are available from Bayer Corporation under the Levamelt trademark (e.g., the Levamelt 400 through Levamelt 800 series).

### Ethylene/Alpha-Olefin Copolymers

Useful elastic polymers include ethylene/alpha-olefin copolymers (“EAOs”) having an average density of at most about 0.912 g/cm3. EAOs are copolymers of ethylene and one or more alpha-olefins, the copolymer having ethylene as the majority mole-percentage content. The comonomer may include one or more C₃-C₂₀ α-olefins, one or more C₄-C₁₂ α-olefins, and one or more C₄-C₈ α-olefins. Useful α-olefins include 1-butene, 1-hexene, 1-octene, and mixtures thereof.

Useful EAOs include those having a density of at most about any of the following: 0.912, 0.91, 0.907, 0.905, 0.903, 0.9, 0.898, 0.895, and 0.89 grams/cubic centimeter. The density may also range between about any of the forgoing values. Unless otherwise indicated, all densities herein are measured according to ASTM D1505.

Useful EAOs include very-low or ultra-low density polyethylene (“VLDPE” and “ULDPE”).

The EAOs may be either heterogeneous or homogeneous. As is known in the art, heterogeneous polymers have a relatively wide variation in molecular weight and composition distribution. Heterogeneous polymers may be prepared with, for example, conventional Ziegler-Natta catalysts.

On the other hand, homogeneous polymers are typically prepared using metallocene or other single-site catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Examples of EAOs useful for the acoustic layer include those having low glass transition temperatures and low levels of crystallinity, such as the ENGAGE 8852 and ENGAGE 8200 polyethylenes (from Dow Chemical Corporation) and EXACT 5062 and EXACT 5361 polyethylenes (from ExxonMobil Corporation).

### Chlorinated Polyethylene

Useful elastic polymers include chlorinated polyethylene (“cPE”). The cPE may have, for example, a chlorine content of at least about, and/or at most about, any of the following values: 10, 15, 20, 23, 25, 30, 35, 40, and 45 weight %. Exemplary cPEs are available from DuPont Dow Elastomers Company under the Tyrin trademark, for example, Tyrin 2500P believed to have a chlorine content of 25 wt % and a Tg of −18.6° C., Tyrin 2136P believed to have a chlorine content of 36 wt % and a Tg of −14.4° C., Tyrin 3615P believed to have a chlorine content of 36 wt % and a Tg of −14.4° C., and Tyrin 361 IP believed to have a chlorine content of 36 wt % and a Tg of −7° C.

### Ethylene/Propylene Copolymer

Useful elastic polymers include ethylene/propylene copolymer (“EPC”), which includes copolymers of propylene and ethylene having a majority weight % content of propylene, such as those having an ethylene comonomer content (weight %) of at most about any of the following: 25, 22, 20, 18, 16, 15, 13, 10, and 6%; and/or at least about any of the following:. 5, 6, 8, 10, 13, 15, 18, and 20%, based on the weight of the copolymer.

### Particles in the Acoustic Layer

An acoustic layer may comprise solid particles dispersed in the acoustic layer. An acoustic layer may comprise at least about any of the following amounts of the particles (described below): 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 50, 60, 70, 80, 100, 120, 140, 160, and 180 weight parts particles per hundred weight parts polymer of the acoustic layer in which the particles are dispersed. An acoustic layer may comprise at most about any of the following amounts of the particles (described below): 200, 180, 160, 140, 120, 100, 80, 70, 60, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, and 7 weight parts particles per hundred weight parts polymer of the acoustic layer in which the particles are dispersed.

One or more acoustic layers may have any of the aforementioned amounts of particles, and in that sense “based on the weight of the acoustic layer” means that each of the one or more acoustic layers has the recited loading of particles based on the individual weight of the respective acoustic layers. Unless specified otherwise, the amount of particles in the one or more acoustic layers is “based on the weight of the acoustic layer” in the sense explained above.

The particles may have an average size in the longest dimension of at least about any of the following: 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 220, 225, 230, 235, 240, 245, 250, 255, 260, 265, 270, 275, 280, 285, 290, 295 microns. The particles may have an average size in the longest dimension of at most about any of the following values: 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 220, 225, 230, 235, 240, 245, 250, 255, 260, 265, 270, 275, 280, 285, 290, 295 and 300 microns.

The particles may have either a theoretical density or an average bulk density (initial, before compaction) of at most about any of the following values: 5, 3, 2.8, 2.6, 2.4, 2.2, 2, 1.8, 1.6, 1.5, 1.4, 1.3, 1.2, and 1 gram/cm3. The particles may have either a theoretical density or an average bulk density of at least about any of the following values: 0.1, 0.5, 0.7, 0.9, 1, 1.2, 1.4, 1.8, and 2 gram/cm3. The bulk density of the particles may be measured according to ASTM D6683-01, which is incorporated herein in its entirety by reference. The theoretical density is that density which is the generally accepted value reported for the material making up the particle, for example, as reported in the CRC Handbook of Chemistry and Physics, 83th Edition.

The particles may have an average surface area of less than about any of the following values: 100, 50, 30, 25, 20, 18, 16, 14, 12, and 10 m2/gram. The particles may have an average surface area of at least about any of the following values: 0.5, 2, 3, 4, 5, 6, 7, 8, 9, 10, 11, 12, 13, 14, and 15 m2/gram. The surface area/mass may be measured by nitrogen adsorption according to one or more of the following ASTM protocols appropriate for the material being tested: ASTM C1069-86, D1993-03, D5604-96, and D6556-02a; or other tests as generally recognized as appropriate for the sample material.

The particles may comprise at least about any of the following amounts of inorganic material: 50, 60, 70, 80, 90, 95, 99, and 100 % by weight of the particles. The particles may consist essentially of inorganic material. The particles may consist of inorganic material.

The particles may comprise at least about any of the following amounts of organic material: 50, 60, 70, 80, 90, 95, 99, and 100 % by weight of the particles. The particles may consist essentially of organic material. The particles may consist of organic material.

Exemplary particle materials comprise: alumina, alumina trihydrate, aluminum, aluminum oxide, aluminum silicate, aluminum trihydroxide, antimony compounds (e.g., antimony oxide), apatite, ash, barium compounds (e.g., barium stearate, barium sulfate), bauxite, bentonite, beryllium oxide, boron nitride, brass, calcium compounds (e.g., calcium carbonate, calcium sulfate, calcium hydroxide, calcium silicate), carbon black, cement dust, ceramic beads, chalk, copper, diatomaceous earth, dolomite, feldspar, ferrous compounds, flyash, feldspar, glass (e.g., glass beads (hollow or solid), glass fibers, glass microballoons or microspheres), graphite, gypsum (e.g., calcined gypsum), iron, iron oxide, lead, lead oxide, lead silicate, limestone, magnesium compounds (e.g., magnesium carbonate, magnesium oxide, magnesium hydroxide), marble dust, metal, metallic compounds, nickel, nickel compounds, organic fillers (e.g., nut shells, rice hulls, cornmeal, wood flour), polymer microballoons, pumice, pyrophyllite, rubber particles, sepiolite, silica (e.g., fumed silica), silica-based materials, silicates (e.g., layered silicates, phyllosilicates, such as clay, as discussed below), silver power, talc, titanium dioxide, titanates, wollastonite, zeolites, zinc, zinc compounds (e.g., zinc oxide), fiberous materials from carbon and cellulose.

Exemplary particle materials also comprise clay, such as smectite clay, for example, bentonite clay (e.g., montmorillonite, hectorite, laponite), mica, vermiculite, bentonite, nontronite, beidellite, volkonskoite, kaolin, kaolinite, and saponite; and layered polysilicate (e.g., layered silicic acid), such as kanemite, makatite, ilerite, octosilicate, magadiite, and kenyaite. The clay may be a nanoclay.

The particles may comprise at least about any of the following amounts of one or more of the above exemplary materials: 50, 60, 70, 80, 90, 95, 99, and 100% by weight of the particles. The particles may consist essentially of one or more of the above exemplary materials. The particles may consist of one or more of the above exemplary materials.

An exemplary particle comprising vermiculite material is available from W.R. Grace & Co. (Grace Building Products) under the FPSV trademark.

An exemplary glass microbubble is available from Minnesota Mining and Manufacturing Company under the SCOTCHLITE K46 trademark (density of about 0.46 g/cc). An exemplary ceramic microsphere is available from Cenospheres, Inc. under the MG-150 BIONIC BUBBLES trademark. Exemplary polymer microballoons include those available from Sovereign Specialty Chemicals under the trademark Micropearls and those available from Akzo-Nobel under the Expancel trademark.

### Adhesive Layer

The laminate may comprise one or more adhesive layers 22. (FIG. 2.) An adhesive layer is an inner laminate layer having the primary purpose of adhering together two layers of the laminate (i.e., the two layers directly adjacent the adhesive layer).

An adhesive layer 22 may comprise one or more of the following polymers:

1. Ethylene/unsaturated ester copolymer, such as any of those described elsewhere in this Application; for example, ethylene/vinyl acetate copolymer (EVA), such as EVA having a vinyl acetate content of at least about any of the following weight % amounts: 3%, 5%, 10%, 15%, 20%, 22%, 24%, and 25%; and for example at most about any of the following weight % amounts: 30%, 28%, 25%, 22%, 20%, 15%, and 10%. EVA also includes, for example, ethylene/vinyl acetate/carbon monoxide terpolymer, for example, having carbon monoxide content of at least about any of the following weight % amounts: 0.1%, 0.5%, 1%, 1.5%, and 2%; and for example at most about any of the following weight % amounts: 5%, 4%, 3%, 2%, and 1%, all based on the weight of the polymer. Useful ethylene/unsaturated ester copolymer also includes ethylene/C₁-C₁₂ alkyl(meth)acrylate copolymers (e.g., ethylene/methyl acrylate copolymer, ethylene/butyl acrylate copolymer, ethylene/methyl methacrylate copolymer), such as any of those described elsewhere in this Application, for example, ethylene/methyl acrylate copolymer having a methyl acrylate content of at least about 20 weight % (e.g., the resin available from the Eastman Chemical Company under the EMAC+SP1305 trademark), also for example, where the copolymer is a block copolymer comprising at least about 20 weight % (meth)acrylate monomer.

2. Ethylene/(meth)acrylic acid copolymers (e.g., ethylene/acrylic acid polymer, ethylene/methacrylic acid copolymer), such as any of those described elsewhere in this Application, for example, an ethylene/acrylic acid available from Dow Corporation under the PRIMACOR 1410 trademark.

3. Polymers modified (e.g., grafted) with unsaturated carboxylic acid anhydride (i.e., anhydride-modified polymer) to incorporate anhydride fimctionality, which promotes or enhances the adhesion characteristics of the polymer. Examples of unsaturated carboxylic acid anhydrides include maleic anhydride, fumaric anhydride, and unsaturated fused ring carboxylic acid anhydrides (e.g., as described in U.S. Pat. No. 4,087,588, which is incorporated herein in its entirety by reference). Examples of anhydride-modified polymers include the anhydride-modified version of any of the polymers listed above in numbers 1-3 as well as any of the other polyolefins (e.g., ethylene homopolymer, ethylene/alpha-olefin copolymer, ethylene/unsaturated ester copolymer, and ethylene/(meth)acrylic acid copolymer) described in this Application, thus including anhydride-modified ethylene homo- and co-polymers and propylene homo- and co-polymers.

Examples of anhydride-modified polymers also include: a) maleic anhydride-grafted linear low density polyethylene available from Rhom and Haas under the TYMOR 1228B trademark, b) maleic anhydride-grafted ethylene/vinyl acetate copolymer available from Dupont Corporation under the BYNEL 3861 trademark, c) ADMER resin (Mitsui Petrochemical Corp; Tokyo, Japan), d) PLEXAR 360 RESIN (Quantum Co.; Cincinnati, Ohio), and e) the LOTADER series of ethylene/alkyl acrylate/maleic anhydride interpolymers (Elf-Atochem, Inc.; Buffalo, N.Y.). Anhydride-modified polymer may be made by grafting or copolymerization, as is known in the art.

Useful anhydride-modified polymers may contain anhydride moiety in an amount (based on the weight of the modified polymer) of at least about any of the following: 0.1%, 0.5%, 1%, and 2%; and at most about any of the following: 10%, 7.5%, 5%, and 4%.

Useful compositions of the adhesive layer may include any of the above recited polymers in at least about any of the following weight percentages based on the weight of the adhesive layer: 50%, 75%, 80%, 85%, 88%, 90%, 93%, 94, 95, 96, 97, 98, and 99%.

Useful adhesive layer thicknesses include at least about, and/or at most about, any of the following values: 0.25, 0.4, 0.5, 0.8, 1, 1.3, 1.5, 2, 2.5, 3, and 5 mils. An adhesive layer may have a thickness relative to the thickness of an acoustic layer of at least about any of the following values: 5%, 10%, 15%, 20%, 30%, 40%, and 50%; and at most about any of the following values: 60%, 50%, 40%, 30%, 20%, and 10%.

An adhesive layer may be between any two of the laminate layers described in this Application. For example, an adhesive layer 22 may be between the core layer 12 and an acoustic layer 14 of the laminate 30. (FIGS. 2 and 4.) An adhesive layer may be directly adjacent the core layer or directly adjacent an acoustic layer or both. In the latter case (i.e., directly adjacent both), the adhesive layer may be considered as directly between the core and acoustic layers, as well as directly adhered to both the core and acoustic layers.

Two or more adhesive layers of the laminate may comprise the same composition or approximate thickness as each other or may comprise a different composition or thickness from each other.

### Decorative Layer

The laminate may comprise a decorative layer 16 adhered to an acoustic layer 14, for example, directly adhered to the acoustic layer 14. The one or more acoustic layers 14 may be between the decorative layer 16 and the core layer 12. A decorative layer may have a primary purpose of providing an ascetically pleasing visual appearance to the laminate. The decorative layer may comprise a veneer layer, an image layer, or both.

A veneer layer may comprise one or more thin layers of wood veneer. The veneer layer may have a thickness of at least about any of 2, 3, 4, 5, 6, and 8 mils; and at most about any of 25, 20, 15, 10, 8, 5, 4, and 3 mils. Wood veneer may be peeled from the circumference of a log in a veneer fashion, or may be plain sawn from wood blocks in board fashion. The veneer layer may comprise wood selected from one or more of birch, beech, ash, maple, oak, walnut, hickory, jatoba, cherry, mahogany, teak, and rosewood.

The veneer layer may comprise a backing of a sheet of paper or fabric bonded to the wood veneer to provide strength and stability. The veneer layer may be impregnated with one or more resins (e.g., melamine-formaldehyde resin), which may be clear in cured form so that the wood grain appearance of the wood veneer may be seen in the finished laminate.

The image layer may comprise paper or other substrate supporting an image such as a photograph of wood grain pattern, tile pattern, stone pattern, or other decorative design. Exemplary paper includes 80-202 grams/m2 ream weight alpha cellulose paper. The image may be provided, for example, by one or more of rotogravure printing, lithographic printing, and electrographic printing. The paper may be impregnated with a water alcohol or water solution of melamine-formaldehyde resin, subsequently dried, compressed, and at least partially cured.

### Wear Layer

The laminate 10, 30 may comprise one or more wear layers 18, the uppermost of which forms an outside top surface 24 of the laminate. The wear layer may be adhered to the acoustic layer, for example, directly adhered to the acoustic layer or directly adhered to a decorative layer that is directly adhered to the acoustic layer. A wear layer primarily functions to contain or protect the ascetic effect of the decorative layer, for example, helping to minimize or reduce the effect of wear, stains, and surface burns. A wear layer may be in the form of a finishing or top coat, and may, for example, be applied to the decorative layer. The wear layer may be clear so that the decorative aspects of the decorative layer may be visible.

The wear layers may comprise one or more of polyurethane, polyvinyl chloride (“PVC”), polyester, acrylic resin, and melamine-formaldehyde resins. The wear layers may also comprise one or more types of relatively hard mineral or inorganic particles (e.g., silica and aluminum oxide particles). Exemplary wear layers are known in the art, for example, as described in U.S. Pat. No. 6,641,629 to Safta et al, which is incorporated herein in its entirety by reference. Useful wear layer thicknesses include at least about, and/or at most about, any of the following values: 1, 5, 10, 20, 50, 100, 200, and 500 mils. The one or more wear layers may be adhered to the decorative layer. At least one of the wear layers may be directly adhered to the decorative layer.

### Backing Layers

One or more backing layers 20 may be adhered to the bottom surface side 26 of the core layer 12, for example, directly adhered to the core layer. A backing layer may function to help balance the core layer and reduce warping, and also to help seal the core layer to reduce the negative effects from moisture absorption into the core layer.

A backing layer 20 may be similar in construction to the decorative layer 16, except without the decorative aspect. For example, the backing layer may comprise a sheet of 120 to 323 gram/m2 dry phenolic resin impregnated kraft paper, formed by impregnating the kraft paper throughout with the phenolic resin that may be substantially cured to a thermoset state during the laminating step discussed below.

The backing layer may comprise one or more of any of the polymers and particles described in the decorative layer and wear layer sections of this Application, in any of the amounts described therein.

### Laminate Configurations

Below are some examples of laminates having varying layer combinations in which the alphabetical symbols designate the layers of the laminate. Where the laminate representation below includes the same letter more than once, each occurrence of the letter represents a different composition within the class that performs a similar function. D/B/A, C/B/A, D/F/B/A, C/F/B/A, D/B/F/A, C/B/F/A, D/F/B/F/A, C/F/B/F/A, D/B/B/A, C/B/B/A, D/B/A/A, C/B/A/A, D/B/B/A/A, D/B/B/A/A, D/D/B/A, C/C/B/A, D/C/B/A, D/C/F/B/A, D/C/B/F/A, D/C/B/F/B/A, D/C/F/B/B/A, D/C/B/B/F/A, D/C/F/B/B/B/A, D/C/F/B/F/A/A, D/C/F/B/F/A/F/A, D/B/A/E, C/B/A/E, D/C/B/A/E, D/F/B/A/E, C/F/B/A/E, D/B/F/A/E, C/B/F/A/E, D/F/B/F/A/E, C/F/B/F/A/E, D/B/B/A/E, C/B/B/A/E, D/B/A/A/E, C/B/A/A/E, D/B/B/A/A/E, D/B/B/A/A/E, D/D/B/A/E, C/C/B/A/E, D/C/B/A/E, D/C/F/B/A/E, D/C/B/F/A/E, D/C/B/F/B/A/E, D/C/F/B/B/A/E, D/C/B/B/F/A/E, D/C/F/B/B/B/A/E, D/C/F/B/F/A/A/E, D/C/F/B/F/A/F/A/E, D/C/B/A/F/E, D/C/F/B/A/E, D/C/B/F/A/E, D/C/F/B/F/A/E.
“A” is a core layer, as discussed above.
“B” is an acoustic layer, which may define a plurality of apertures, as discussed above.
“C” is a decorative layer, as discussed above.
“D” is a wear layer, as discussed above.
“E” is a backing layer, as discussed above.
“F” is an adhesive layer, as discussed above.

### Manufacture and Use of the Laminate

The laminate may be made by superimposing the layers and laminating them together under heat and pressure, for example, using any of the high pressure laminate, direct pressure laminate, and continuous multi-layer laminate methods. The high pressure laminate method may use, for example, a pressure of about 1,400 pounds-per-square inch of pressure. The direct pressure laminate method may utilize a single press operation to adhere (e.g., fuse) the layers together and may use, for example, from about 300 to about 500 pounds-per-square inch of pressure.

The pressure and heat of the lamination may force the resin in any impregnated sheets to flow and cure to consolidate the layers into a laminated mass.

The laminate may be formed by laminating a multilayer sheet to a core layer, where the multilayer sheet comprises an acoustic layer and one or more other layers, such as one or more adhesive layers and/or one or more additional acoustic layers. In such case, the acoustic layer and the one or more adhesive or other layers are adhered together (e.g., formed by coextrusion) to form the multilayer sheet before it is laminated to the core layer. For example, the multilayer sheet may comprise an acoustic layer and at least one adhesive layer. The at least one adhesive layer (in the multilayer sheet existing before the lamination step) may be directly adjacent the acoustic layer, or the adhesive layer may be spaced from the acoustic layer by one or more other layers. Also by way of example, the multilayer sheet existing before the lamination step may comprise an acoustic layer, a first adhesive layer, and a second adhesive layer. The first and second layers may be on opposing sides of the acoustic layer. The first and second adhesive layers may be directly adjacent to the acoustic layer, or one or both of the first and second adhesive layers may be spaced from the acoustic layer by one or more other layers.

The multilayer sheet may be formed, for example, by one or more of the thermoplastic film-forming processes known in the art (e.g., tubular or blown-film extrusion, coextrusion, extrusion coating, spray coating, flat or cast film extrusion). The sheet and/or the acoustic layer may also be formed by calendering.

The acoustic layer, and/or the multilayer sheet comprising the acoustic layer, may be cross-linked, for example, to enhance the strength of the layer or sheet. Cross-linking may be achieved by using chemical additives or by subjecting the layers to one or more energetic radiation treatments—such as ultraviolet, X-ray, gamma ray, beta ray, and high energy electron beam treatment—to induce cross-linking between molecules of the irradiated material. Useful radiation dosages include at least about any of the following: 5, 7, 10, 15, 20, 25, 30, 35, 40, 45, and 50 kGy (kiloGray). Useful radiation dosages include less than about any of the following: 150, 130, 120, 110, 100, 90, 80, and 70 kGy.

To form a laminate using the multilayer sheet comprising the acoustic layer and one or more adhesive layers, the multilayer sheet may be superimposed with other layers (e.g., the core layer and decorative layer) and subjected to sufficient heat and pressure in a lamination step to soften the one or more adhesive layers to effect an adhesive bond with the other layers of the laminate.

One or more layers, such as an adhesive layer, may be formed on the acoustic layer by spray coating, for example, by spray coating an adhesive directly onto the acoustic layer. The resulting multilayer sheet may then be superimposed with the other layers and subjected to sufficient heat and pressure to effect an adhesive bond with the other layers and to form a laminate.

A laminate comprising one or more apertured acoustic layers may be made by perforating an acoustic layer before it superimposed with the other layers and laminated to form the laminate. For example, a sheet comprising one or more acoustic layers may be perforated before the sheet is used in the lamination step discussed above. The sheet (and thus the one or more acoustic layers) may be perforated, for example, by hot or cold needle perforation, or by hole-punching, so that an acoustic layer has any of the average open aperture areas, average aperture sizes, average aperture area densities, and aperture configurations described above with respect to the acoustic layer in the laminate. When the apertured sheet is subsequently laminated with the other layers of the laminate, the apertures of the acoustic layer may tend to become smaller as a result of the heat and pressure associated with the lamination process. Accordingly, it may be advisable to form apertures in the acoustic layer before lamination that are larger than the final size of the apertures that are desired for the acoustic layer after lamination to form the laminate.

As another way to provide a plurality of apertures, the acoustic layer or sheet may comprise one or more materials (i.e., layers or sheets) selected from: 1) a woven or knitted sheet or layer having mesh openings (i.e., apertures) between the filaments of the material, 2) an extruded (e.g., coextruded) net, mesh, or screen, and 3) a non-woven sheet or layer having apertures by virtue of the multiple continuous open pathways between the filaments of the non-woven material. Examples of woven sheets or layers include woven meshes, nets, and screens. Non-woven sheets or layers are those that comprise numerous filaments that are matted and/or pressed together (rather than woven or knitted) to form the material. The non-woven, woven, or knitted layer or sheet may comprise bi-component filaments (e.g., core and sheath filaments), multi-component filaments, or may comprise or consist essentially of single-component filaments. The extruded mesh, net, or screen may have a first composition in one direction (e.g., machine direction) and a differing second composition in another direction (e.g., the transverse direction), or may have predominantly the same composition in any direction. The extruded mesh, net, or screen may be formed, for example, using strand dies, and may be oriented or essentially non-oriented.

Still another way to provide the apertured sheet or layer is by providing an apertured substrate that is subsequently coated with a coating comprising at least about, and/or at most about, 40, 50, 60, 70, 80, 90, 95, 98, and 100 weight % (based on the weight of the coating) of one or more of any of the elastic polymers discussed above with respect to the acoustic layer. The apertured substrate may comprise at least about, and/or at most about, 40, 50, 60, 70, 80, 90, 95, 98, and 100 weight % (based on the weight of the apertured substrate) of one or more of the following materials: metal, glass (e.g., glass fibers), cellulosic material, thermoplastic polymer, thermoset polymer, elastomeric polymer, natural material, cloth, and textile. The coating may be applied to the apertured substrate, for example, by one or more methods such as spray coating and dip coating.

The laminate may be used in flooring systems, furniture, wall panel systems, watercraft (e.g., ships), and automobiles. The laminate may be configured in blocks, planks, or squares for installation use as individual units. For example, a flooring article (e.g., a plank or tile) comprising the laminate may have a length of at least about any of the following: 10 inches and 2 feet; and may have a width of at least about 2 inches. Such a flooring article may be used as part of a flooring system in which a plurality of the articles comprising the laminate are positioned on top of a subfloor comprising materials selected from concrete, wood, and wood composite. The flooring article may be affixed to the subfloor, or the flooring article (e.g., plank) may be installed as a floating flooring system. The flooring article may be installed on top of a floor underlayment that is placed on top of the subfloor. Useful floor underlayments are known in the art, and therefore are not discussed in detail here. An exemplary floor system 40 is illustrated in FIG. 2. Floor system 40 comprises floor article (e.g., plank) 42, which comprises laminate 30. The floor system 40 may also comprise floor underlayment 44 and subfloor 46. The floor article rests on top of floor underlayerment 44, which in turn rests on top of subfloor 46.

The laminate may be used as part of any structure in which it may be desirable to modify the pitch of sound generated by impact, in particular preferentially reducing the intensity of reflected impact sound in the 4,000 to 12,500 Hz range.

The following examples are presented for the purpose of further illustrating and explaining the present invention and are not to be taken as limiting in any regard. Unless otherwise indicated, all parts and percentages are by weight.

In the samples below, the following abbreviations have the following meanings:

CPE1 is a chlorinated polyethylene having a 42 weight % chlorine content and a Tg of −1° C. available from Dow Corporation under the Tyrin 4211 trademark.

EMA-AA1 is an ethylene/methyl acrylate/acrylic acid copolymer having 6.5 wt % methyl acrylate content and 6.5 wt % acrylic acid content and a Tg of 11° C. available from ExxonMobil Corporation under the Escor AT 310 trademark.

EVA1 is an ethylene/vinyl acetate copolymer having a vinyl acetate content of 60 weight % and a Tg of −26° C. available from Bayer Corporation under the Levamelt 600 trademark.

EVA2 is an ethylene/vinyl acetate copolymer having a vinyl acetate content of 70 weight % and a Tg of −15° C. available from Bayer Corporation under the Levamelt 700 trademark.

EVA3 is an ethylene/vinyl acetate copolymer having a vinyl acetate content of 80 weight % and a Tg of 1° C. available from Bayer Corporation under the Levamelt 800 trademark.

HDF1 is a high density fiberboard having a thickness of 0.25 inches.

LDPE1 is a low density polyethylene having a density of 0.919 g/cm and a Tg of less than −25° C. available from Nova Chemical Company under the Nova EH-11 trademark.

SBS1 is a styrene/butadiene/styrene copolymer having a Tg of −105° C. available under the Kraton 2104 trademark from Shell Corporation

SIS1 is a hydrogenated styrene/isoprene/styrene block copolymer having a Tg of −14° C. available from Kuraray Corporation under the Hybrar 7125F trademark.

ULDPE1 is an ultra low density polyethylene copolymer having a density of 0.87 g/cm and a Tg of −52° C. available from Dow Corporation under the Engage 8100 trademark.

Veneer 1 is a paper-based decorative layer having a thickness of 21 mils and a wood-grain image for use in a high-pressure floor laminate.

### EXAMPLES

Three-layer laminates were made having decorative, internal, and core layers, as set forth in Table 1. The layers were superimposed so that the internal layer was between the decorative and core layers. The Sample 1-8 laminates and the Compare 3-7 laminates were then formed by hot pressing the layers to bond them together at about 180° C. and 25 psi. The Compare 2 laminate was formed by using wood glue to adhere the decorative layer to the core layer. The Compare 1 structure was not a laminate, but was a solid oak hardwood flooring having a thickness of 0.75 inches.

A 77.5 mil floor underlayment sheet comprising a 75 mil foam LDPE middle layer and two HDPE skin layers was placed on a concrete block (representing a concrete subfloor). Representative 6-inch by 6-inch samples of the Tables 1 and 2 structures were placed on top of the underlayment sheet.

A one-inch diameter stainless steel ball bearing was dropped from a height of 12 inches onto the center of each laminate or hardwood sample. The ball bearing hit the surface of the sample to create an impact sound that was picked up by a microphone suspended 12 inches above the structure. The intensity and frequency of the impact sound was digitally recorded and processed via fast Fourier transform. The procedure was performed twice for each structure, and the results averaged. The sound intensity (dB) versus frequency (Hz) was analyzed in ⅓^{rd} octave increments over a frequency range of from 20 Hz to 12,500 Hz.

It was determined that at frequencies generally from about 1,000 Hz to 12,500 Hz, and in particular in the range of from 4,000 Hz to 12,500 Hz, the Commercial Laminates 1-3 generated a higher impact sound intensity compared to the Compare 1 structure (i.e., the hardwood flooring). However, at frequencies from 20 to about 1,000 Hz, the Commercial Laminates 1-3 and the Compare 1 hardwood structure had similar impact sound intensity responses. Thus, the impact sound for the Commercial Laminates 1-3 was louder at higher pitches compared to the Compare 1 hardwood structure. This was confirmed subjectively by several persons, who reported that the impact sound for the Commercial Laminates 1-3 sounded higher pitched than the impact sound for the Compare 1 hardwood structure.

The average of the impact sound intensity (dB) over ⅓^{rd} octave increments for the range of from 4,000 Hz to 12,500 Hz was calculated for each structure and is reported in Tables 1 and 2.

TABLE 1
Impact Sound Intensity with Concrete Subfloor and Underlayment

| | Decorative | | | Impact Sound |
|---|---|---|---|---|
| | Layer | Internal Layer | Core Layer | Intensity (dB)* |
| Sample 1 | 21 mils | SBS1, 20 mils, | 250 mils | 74 |
| | Veneer1 | Tg = −105° C.; | HDF1 | |
| | | Wc = about 30%. | | |
| Sample 2 | 21 mils | EVA1, 20 mils, | 250 mils | 75 |
| | Veneer1 | Tg = −26° C., | HDF1 | |
| | | Wc = about 0%. | | |
| Sample 3 | 21 mils | EVA2, 20 mils, | 250 mils | 75 |
| | Veneer1 | Tg = −15° C., | HDF1 | |
| | | Wc = about 0%. | | |
| Sample 4 | 21 mils | ULDPE1, 20 mils, | 250 mils | 76 |
| | Veneer1 | Tg = −52° C., | HDF1 | |
| | | Wc = about 20%. | | |
| Sample 5 | 21 mils | SIS1, 20 mils | 250 mils | 76 |
| | Veneer1 | Tg = −14° C., | HDF1 | |
| | | Wc = about 20%. | | |
| Sample 6 | 21 mils | SBS1, 30 mils | 250 mils | 74 |
| | Veneer1 | Tg = −105° C., | HDF1 | |
| | | Wc = about 30%. | | |
| Sample 7 | 21 mils | SBS1, 15 mils | 250 mils | 76 |
| | Veneer1 | Tg = −105° C., | HDF1 | |
| | | Wc = about 30%. | | |
| Sample 8 | 21 mils | SBS1, 10 mils, | 250 mils | 79 |
| | Veneer1 | Tg = −105° C., | HDF1 | |
| | | Wc = about 30%. | | |
| Compare 1 | none | none | 750 mils | 71 |
| | | | Oak hardwood. | |
| Compare 2 | 21 mils | <1 mil | 250 mils | 83 |
| | Veneer1 | Wood glue | HDF1 | |
| Compare 3 | 21 mils | EVA3, 20 mils, | 250 mils | 82 |
| | Veneer1 | Tg = 1° C., | HDF1 | |
| | | Wc = about 0%. | | |
| Compare 4 | 21 mils | 90% CPE1 (Tg = −1° C.; Wc < about | 250 mils | 81 |
| | Veneer1 | 5%), | HDF1 | |
| | | 10% mineral oil, | | |
| | | 20 mils, | | |
| | | Tg blend = 5.2° C. | | |
| Compare 5 | 21 mils | EMA-AA1, 20 mils, | 250 mils | 83 |
| | Veneer1 | Tg = 11° C., | HDF1 | |
| | | Wc > about 40%. | | |
| Compare 6 | 21 mils | LDPE1, 20 mils, | 250 mils | 82 |
| | Veneer1 | Tg <−25° C., | HDF1 | |
| | | Wc = about 40%. | | |
| Compare 7 | 21 mils | SBS1, 5 mils, | 250 mils | 82 |
| | Veneer1 | Tg = −105° C., | HDF1 | |
| | | Wc = about 30%. | | |

*average taken from 4,000 to 12,500 Hz over ⅓^{rd} octave increments.

TABLE 2
Impact Sound Intensity with Concrete Subfloor and Underlayment

| | | Thickness | Impact Sound |
|---|---|---|---|
| | Type | (mils) | Intensity (dB)* |
| Commercial | Multi-layer floor laminate | 281 | 86 |
| Floor | believed to have wear, | | |
| Laminate 1 | decorative, core, and | | |
| | backing layers. | | |
| Commercial | Multi-layer floor laminate | 312 | 82 |
| Floor | believed to have wear, | | |
| Laminate 2 | decorative, core, and | | |
| | backing layers. | | |
| Commercial | Multi-layer floor laminate | 312 | 92 |
| Floor | believed to have wear, | | |
| Laminate 3 | decorative, core, and | | |
| | backing layers. | | |

*average taken from 4,000 to 12,500 Hz over ⅓^{rd} octave increments.

The Compare 2 laminate, which had only a thin internal layer of wood glue, had an 83 dB impact sound intensity at the higher pitch range (i.e., 4,000 to 12,500 Hz). The inclusion of a 10 to 30 mils internal layer having glass transition temperatures that ranged from −12° C. to −105° C. (Samples 1-8) and crystallinities ranging from about 0% to about 30% unexpectedly lowered the higher pitched impact sound intensities to below 80 dB. Further, the Samples 1-8 impact sound intensities ranged from 74 to 79 dB, which approached the 71 dB impact sound intensity of the Compare 1 hardwood sample. Thus, it is believed that the Samples 1-8 laminates sounded more like a “real” hardwood floor than did the Commercial Laminates 1-3, which had impact sound intensities ranging from 86 to 92 dB.

The Compare 3-6 laminates had 20 mil internal layers with glass transition temperatures above 0° C. (Compare 3-5) and/or a crystallinity of at least about 40 weight % (Compare 5-6). The Compare 7 laminate had only a 5 mil internal layer with a Tg of −105° C. and a Wc of about 0%. Yet these laminates had from 81 to 83 dB impact sound intensities at the higher frequency range. These results are comparably close to the 83 dB result for the Commercial Laminate 2, and also to the 83 dB result for the Compare 2 laminate, which had only a thin layer of wood glue as an internal layer.

The inclusion of the internal layers of Samples 1-8 laminates were surprisingly more effective in lowering the intensity of reflected impact sound at the higher frequency range than were the internal layers of the Compare 3-7 laminates. It is believed that an internal layer having sufficient elasticity, for example characterized by a Tg of less than about 0° C. and a Wc of at most about 39 weight %, surprisingly resulted in a lowered intensity of reflected impact sound at the higher frequency range.

### Apertured Acoustic Layer Example

A three-layer laminate (Sample 9) was made as set forth for Sample 1 above, with the exception that that the internal layer (i.e., the acoustic layer) of Sample 9 was perforated before the layers were superimposed and bonded together. The layer was perforated by punching a regular array of 5 mm diameter circular holes spaced 25 mm apart from each other.

The intensity and frequency of the ball bearing impact sound for Sample 9 was tested, recorded, and processed as set forth above for Sample 1. The impact sound testing results for Sample 9 were compared to those of Sample 1 over the frequency range of 10 to 10,000 Hz. It was found that the impact sound intensities were essentially the same for Sample 9, having a perforated internal layer, as for Sample 1, having a non-perforated internal layer of the same composition and thickness. It was surprising and unexpected that the incorporation of an internal acoustic layer defining a plurality of apertures did not appear to negatively affect the impact sound intensity response of the laminate.

Any numerical values recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

What is claimed is:

1. A laminate comprising:
a core layer comprising one or more materials selected from wood and wood composite, wherein the core layer has a thickness of at least about 30 mils; and
one or more acoustic layers adhered to the core layer, wherein the one or more acoustic layers:
define a plurality of apertures;
have a total thickness of greater than about 5 mils;
comprise one or more polymers; and
have a characteristic selected from at least one of:
a) a glass transition temperature of at most about 0° C. combined with a crystallinity of at most about 39 weight %; and
b) comprising at least about 40 weight % elastic polymer.

2. The laminate of claim 1 wherein the average of the area of the plurality of apertures per the area of the one or more acoustic layers defining the plurality of apertures is at least about 0.5%.

3. The laminate of claim 1 wherein the water vapor transmission rate through the laminate is at least about 1 gram/100 in².24 hours (100% humidity, 23° C.).

4. The laminate of claim 1 wherein the one or more acoustic layers defines at least about 2 apertures per 100 cm², wherein the plurality of apertures has an average aperture cross-section area of at least about 0.5 mm².

5. The laminate of claim 1 wherein the one or more acoustic layers defining a plurality of apertures comprises one or more materials selected from a woven layer, a knitted layer, and a non-woven layer.

6. The laminate of claim 1 wherein the one or more acoustic layers comprise a polymer selected from styrene/butadiene/styrene block copolymer, styrene/isoprene/styrene block copolymer, styrene/ethylene-butylene/styrene block copolymer, styrene/ethylene-propylene/styrene block copolymer, and styrene/ethylene-propylene block copolymer.

7. The laminate of claim 1 wherein the one or more acoustic layers comprise ethylene/unsaturated ester copolymer.

8. The laminate of claim 1 wherein the one or more acoustic layers comprise ethylene/alpha olefin copolymer having a density of at most about 0.912 g/cm3.

9. The laminate of claim 1 wherein the one or more acoustic layers comprise chlorinated polyethylene.

10. The laminate of claim 1 wherein the one or more acoustic layers comprise ethylene/propylene copolymer.

11. The laminate of claim 1 wherein the one or more acoustic layers comprise one or more elastic polymers selected from acrylonitrile/chloroprene copolymer, acrylonitrile/isoprene copolymer, butadiene/acrylonitrile copolymer, chlorosulfonated polyethylene, ethylene ether polysulfide, ethylene polysulfide, ethylene/propylene/diene terpolymer, fluoroelastomer, fluorosilicone, hexafluoropropylene/vinylidene fluoride copolymer, isobutene/isoprene copolymer, organopolysiloxane, acrylic ester/butadiene copolymer, polybutadiene, polychloroprene, polyepichlorohydrin, polyisobutene, polyisoprene, polyurethane, and polyethylene-butyl graft copolymer.

12. The laminate of claim 1 wherein the one or more acoustic layers have a glass transition temperature of at most about 0° C. combined with a crystallinity of at most about 39 weight %.

13. The laminate of claim 1 wherein the one or more acoustic layers comprise at least about 40 weight percent elastic polymer based on the weight of the acoustic layer.

14. The laminate of claim 1 wherein the one or more acoustic layers have a crystallinity of less than about 38 weight %.

15. The laminate of claim 1 wherein the one or more acoustic layers have a glass transition temperature of at most about −5° C.

16. The laminate of claim 1 wherein the one or more acoustic layers have a glass transition temperature of at most about −10° C.

17. The laminate of claim 1 wherein the core layer has a thickness of at least about 100 mils.

18. The laminate of claim 1 further comprising a decorative layer adhered to the one or more acoustic layers, wherein the one or more acoustic layers are between the decorative layer and the core layer.

19. The laminate of claim 1 wherein one of the one or more acoustic layers is directly adhered to the core layer.

20. The laminate of claim 1 further comprising a decorative layer, wherein one of the one or more acoustic layers is directly adhered to the decorative layer.

21. The laminate of claim 1 wherein the total thickness of the one or more acoustic layers is at least about 10 mils thick.

22. The laminate of claim 1 wherein:
the laminate defines a top surface and an opposing bottom surface;
the top surface is closer to the one or more acoustic layers than is the bottom surface; and
the one or more acoustic layers are a distance of at most about 40 mils from the top surface.

23. The laminate of claim 1 wherein the one or more acoustic layers are a distance of at most about 30 mils from the core layer.

24. A method of making the laminate of claim 1 comprising:
providing a sheet comprising the one or more apertured acoustic layers;
subsequently superimposing the perforated sheet with the core layer; and
pressing the multilayer sheet and the core layer under sufficient heat and pressure to bond the sheet and core layer to each other.

25. A method of making the laminate of claim 1 comprising:
perforating a sheet to form a plurality of apertures in one or more acoustic layers;
subsequently superimposing the perforated sheet with the core layer; and
pressing the multilayer sheet and the core layer under sufficient heat and pressure to bond the sheet and core layer to each other.

26. A flooring article comprising the laminate of claim 1, wherein the flooring article has a length of at least about 10 inches and a width of at least about 2 inches.

27. A flooring system comprising a plurality of the flooring articles of claim 26 positioned on top of a subfloor comprising a material selected from concrete, wood, and wood composite.
